(19) United States
(12) Patent Application Publication
(10) Pub. No.: US 2026/0133715 A1
(43) Pub. Date: May 14, 2026

(54) STORAGE SYSTEM AND STORAGE MANAGEMENT METHOD

(71) Applicant: Hitachi Vantara, Ltd., Yokohama-shi (JP)

(72) Inventors: Kazuki TOGO, Tokyo (JP); Tsukasa SHIBAYAMA, Tokyo (JP)

(21) Appl. No.: 19/075,251

(22) Filed: Mar. 10, 2025

(30) Foreign Application Priority Data
Nov. 8, 2024 (JP) 2024-195921

(51) Int. Cl. G06F 3/06

(52) U.S. Cl. CPC G06F 3/065; G06F 3/0619; G06F 3/067

(57) ABSTRACT

A controller is capable of executing virtual copy clone creation processing of creating a clone volume by virtual copy sharing data with an existing volume and physical copy clone creation processing of creating a clone volume by physically copying data from the existing volume, and determines, based on the number of existing and to-be-created clone volumes and an upper limit of the number of clone volumes to be created by the virtual copy clone creation processing, which of the virtual copy clone creation processing and the physical copy clone creation processing is to be executed, and executes the processing.

### CROSS-REFERENCE TO RELATED APPLICATION

The present application claims priority from Japanese application JP 2024-195921, filed on Nov. 8, 2024, the content of which is hereby incorporated by reference into this application.

### BACKGROUND OF THE INVENTION

### 1. Field of the Invention

The present invention relates to a storage system and a storage management method, and is suitably applied to, for example, a storage system related to a technique for creating a clone volume by virtual copy.

### 2. Description of Related Art

As a method of speeding up data copying in recent storage systems, there is a method of updating only metadata as a pointer indicating a storage position of the data without actually copying the data. Hereinafter, this method is also referred to as “redirect-on-write (RoW)”. By using RoW, a snapshot can be created for data at a certain time point.

For example, a storage system using a function called storage policy based management (SPBM) sets a policy when creating a virtual machine (hereinafter, also referred to as “VM”), and automatically creates a virtual volume satisfying the policy on the storage system. The storage system needs to create a virtual volume that satisfies a policy specified by a VM administrator and then continue to maintain the policy. Examples of such a policy include a snapshot policy. The snapshot policy includes, for example, a snapshot cycle and a snapshot retention period. Patent Literature 1 discloses a technique of creating and using a clone volume that does not involve physical copy.

### CITATION LIST

### Patent Literature

Patent Literature 1: JP2022-26812A

### SUMMARY OF THE INVENTION

However, in the technique disclosed in Patent Literature 1, when a clone volume that does not involve physical copy is created, there is a risk that the policy cannot be maintained thereafter.

The invention has been made in view of the above points, and proposes a storage system and a storage management method capable of always maintaining a policy even when a clone volume is created by virtual copy.

In order to solve such problems, the invention provides a storage system including a drive configured to physically store data; and at least one controller configured to provide a volume to a host computer and control input/output processing of data via the volume, in which the controller is configured to execute virtual copy clone creation processing of creating a clone volume by virtual copy sharing data with an existing volume and physical copy clone creation processing of creating a clone volume by physically copying data from the existing volume, estimate the number of clone volumes to be created by the virtual copy clone creation processing, and determine, based on the number of existing and to-be-created clone volumes and an upper limit of the number of clone volumes to be created by the virtual copy clone creation processing, which of the virtual copy clone creation processing and the physical copy clone creation processing is to be executed, and execute the processing.

The invention provides a storage management method for a storage system, the storage system including a drive configured to physically store data, and at least one controller configured to provide a volume to a host computer and control input/output processing of data via the volume, the method includes: executing, by the controller, virtual copy clone creation processing of creating a clone volume by virtual copy sharing data with an existing volume and physical copy clone creation processing of creating a clone volume by physically copying data from the existing volume; and determining, by the controller, based on the number of existing and to-be-created clone volumes and an upper limit of the number of clone volumes to be created by the virtual copy clone creation processing, which of the virtual copy clone creation processing and the physical copy clone creation processing is to be executed, and executing the processing.

According to the invention, a policy can always be maintained even if a clone volume is created by virtual copy.

### BRIEF DESCRIPTION OF THE DRAWINGS

FIG. 1 is a system configuration diagram illustrating an example of an overall configuration of an information processing system according to the present embodiment;

FIG. 2 is a system configuration diagram illustrating a software configuration example of a storage node illustrated in FIG. 1;

FIG. 3 is a software configuration diagram illustrating an example of a storage content of a memory of the storage node illustrated in FIG. 2;

FIG. 4 is a configuration diagram of a virtual volume management table illustrated in FIG. 3;

FIG. 5 illustrates image diagrams each illustrating a configuration example of a snapshot and virtual clone tree of a virtual volume according to the present embodiment;

FIG. 6 is a diagram illustrating a configuration example of a policy management table illustrated in FIG. 3;

FIG. 7 is a configuration diagram of a volume management table illustrated in FIG. 3;

FIG. 8 is a diagram illustrating a configuration example of a snapshot/virtual clone management table illustrated in FIG. 3;

FIG. 9 is a diagram illustrating a configuration example of a local copy management table illustrated in FIG. 3;

FIG. 10 is a diagram illustrating a configuration example of a volume migration management table illustrated in FIG. 3;

FIG. 11 is a flowchart illustrating an example of a storage management method including virtual volume clone processing and policy change processing according to the present embodiment;

FIG. 12 is a flowchart illustrating an example of a procedure of the virtual volume clone processing illustrated in FIG. 11;

FIG. 13 is a flowchart illustrating an example of a procedure of snapshot policy maintenance availability check processing illustrated in FIG. 12;

FIG. 14 is a flowchart illustrating an example of a procedure of a virtual copy clone creation processing illustrated in FIG. 12;

FIG. 15 is a flowchart illustrating an example of a procedure of local copy clone creation processing illustrated in FIG. 12;

FIG. 16 is a flowchart illustrating an example of a procedure of the policy change processing illustrated in FIG. 11;

FIG. 17 is a flowchart illustrating an example of a procedure of snapshot policy maintenance availability check processing in the policy change processing illustrated in FIG. 16; and

FIG. 18 is a flowchart illustrating an example of a procedure of volume migration processing illustrated in FIG. 16.

### DESCRIPTION OF EMBODIMENTS

Hereinafter, the present embodiment of the invention will be described in detail with reference to the drawings. The embodiments described below do not limit the invention according to the range of claims, and it is not necessary that all of the elements and combinations described in the embodiments are essential to the solution means of the invention.

In the following description, information may be described by an expression of “AAA table”, whereas the information may be expressed in any data structure. That is, in order to indicate that the information does not depend on the data structure, the “AAA table” can be referred to as “AAA information”.

In the following description, processing may be described with a program as a subject of operation, but since the program is executed by a processor (for example, a central processing unit (CPU)) to perform predetermined processing while appropriately using a storage resource (for example, a memory) and/or a communication interface device (for example, a network interface card (NIC)), the subject of the processing may be the processor. The processing described with the program as the subject of the operation may be processing performed by a processor or a computer (system) including the processor.

In the following description, two or more programs may be implemented as one program, or one program may be implemented as two or more programs.

In the following description, “VOL” is an abbreviation for logical volume and may be a logical storage device. The VOL may be a substantive volume (a volume based on a physical storage device) or a virtual volume.

A virtual volume (VVOL) as an example of a virtual volume used in the following embodiments is implemented by a subsidiary logical unit (SLU), which is a logical unit (LU) whose specifications are defined in a Conglomerate LUN structure, which is a Small Computer System Interface (SCSI) architecture model, and may also be referred to as an SLU. The SLU is a logical unit serving as a logical storage area based on a physical storage area of a storage device, and access from a host is implemented by setting a connection relation (binding) with a volume that serves as a receiving point for access (IO request) from a host called an administrative logical unit (ALU). The ALU may be referred to as a protocol endpoint (PE). The SLU and the ALU may be implemented as the logical volume.

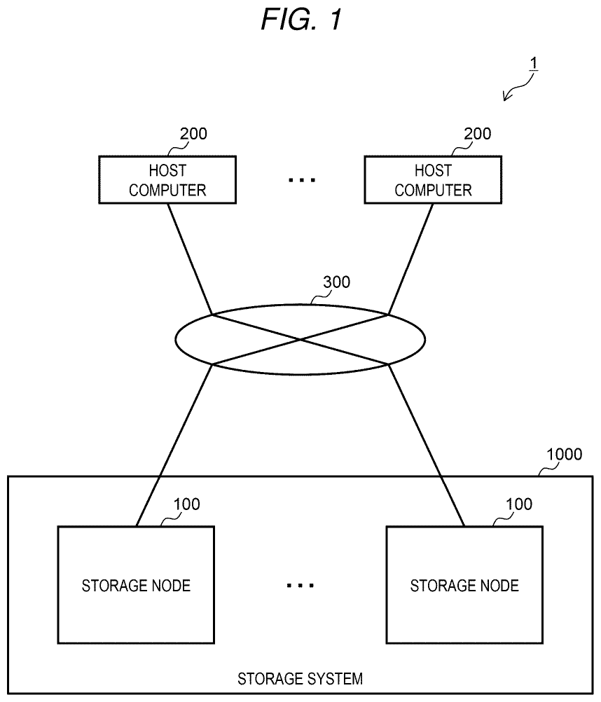

FIG. 1 is a system configuration diagram illustrating an example of an overall configuration of an information processing system 1 according to the present embodiment. The information processing system 1 includes a storage system 1000 and host computers 200. The storage system 1000 includes one or more storage nodes 100. The storage system 1000 may be referred to as a storage cluster.

The storage node 100 and the host computer 200 are connected to each other via a network 300, and can exchange data and the like. The network 300 may be, for example, a local area network (LAN), or a wide area network (WAN).

The storage node 100 is a device that provides for the host computer 200 with a storage area for reading and writing data. The storage node 100 may be a physical computer or a virtual computer.

The storage system 1000 includes an application programming interface (API) server that receives from the host computer 200 an API request for a management operation such as creation of a virtual volume. The API server may be implemented in the storage node 100. Alternatively, the API server may be implemented by preparing another server (computer) capable of communicating with the storage node 100 and the host computer 200. In the following embodiment, a case in which the API server is implemented in the storage node 100 will be described as an example.

The host computer 200 is a computer that transmits a read/write request to the storage system 1000 in response to a request from a user operation or an application program (for example, a file server program or a database server program). Hereinafter, the read/write request is referred to as an input/output (I/O) request. The host computer 200 may be a physical computer, a virtual computer such as a virtual machine (hereinafter, also referred to as “VM”), or a configuration in which one or more virtual machines are constructed in the host computer 200. For example, when a plurality of the storage nodes 100 constitute a cluster, a multipath is set between the host computer 200 and the storage nodes constituting the cluster. When Linux (registered trademark) is used, for example, the multipath can be set by using multipath-tools, for example. On the other hand, when the host computer 200 is, for example, a windows server (registered trademark), the multipath can be set by using, for example, a multipath input/output (MPIO) service. The host computer 200 may be, for example, an on-premises device, or alternatively, may be a cloud-based device.

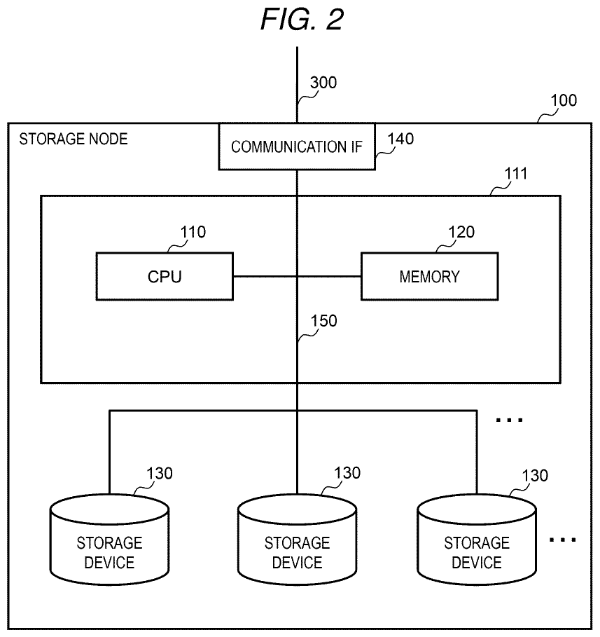

FIG. 2 is a system configuration diagram illustrating a software configuration example of the storage node 100 illustrated in FIG. 1.

The storage node 100 includes at least storage devices 130 each serving as an example of a drive in which a volume that physically stores data is created, and at least one controller 111 that controls input/output processing of data via the volume. The controller 111 includes a CPU 110, a memory 120, a plurality of the storage devices 130, and a communication interface (hereinafter, referred to as “I/F”) that are connected to each other via an internal network 150. The CPU 110, the memory 120, the storage device 130, and the communication I/F included in each storage node 100 may be, for example, one or more, respectively.

The CPU 110 is a processor that controls operations of the overall storage node 100. The CPU 110 executes various types of processing based on programs and management information stored in the memory 120. The CPU 110 may be a physical CPU of a physical computer, or alternatively, may be a virtual CPU in which a physical CPU of a physical computer is virtually allocated using a cloud virtualization function.

The memory 120 is a volatile semiconductor memory such as a static random access memory (SRAM) or a dynamic random access memory (DRAM). The memory 120 stores various programs to be executed by the CPU 110 and management information to be referred to or updated by the CPU 110. The memory 120 may be a physical memory, or alternatively, may be a virtual memory in which a physical memory is virtually allocated using a cloud virtualization function.

The storage device 130 is a storage device that stores user data to be used by the host computer 200. The storage device 130 may be, for example, a non-volatile storage device. The storage device 130 may be, for example, a hard disk drive (HDD) or a solid state drive (SSD). The storage device 130 may be a physical storage device, or alternatively, may be a virtual storage device in which a physical storage device is virtually allocated using a cloud virtualization function.

The communication I/F 140 is an interface for the storage node 100 to communicate with the host computer 200, another storage node 100, or a management device via the network 300. The communication I/F 140 is, for example, a network interface card (NIC) or a fibre channel (FC) card. The communication I/F 140 may be a physical communication I/F, or alternatively, may be a virtual communication I/F in which a physical communication I/F is virtually allocated using a cloud virtualization function.

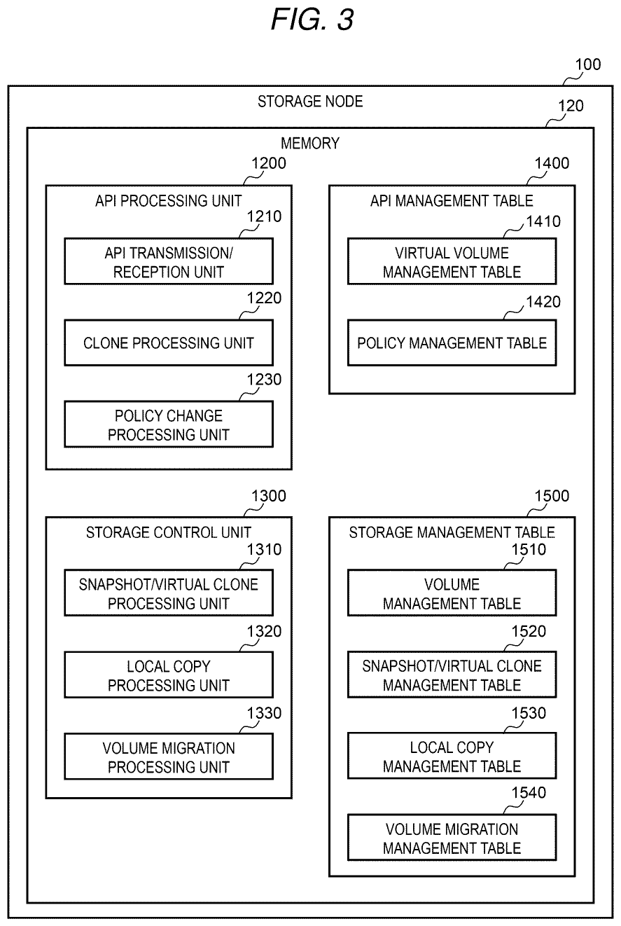

FIG. 3 is a software configuration diagram illustrating an example of a storage content of the memory 120 of the storage node 100 illustrated in FIG. 2.

The memory 120 of the storage node 100 stores an API processing unit 1200, a storage control unit 1300, an API management table 1400, and a storage management table 1500.

The API processing unit 1200 and the storage control unit 1300 may operate as a program, for example, and may be implemented as one program, or alternatively, may be implemented as two or more programs.

The API processing unit 1200 operates as, for example, an API server. The API processing unit 1200 executes an operation of receiving an API request for a management operation from the host computer 200. The API processing unit 1200 performs internal processing in the API processing unit 1200 or transmits an instruction to the storage control unit 1300 according to a content of the received API request.

The API processing unit 1200 includes an API transmission/reception unit 1210, a clone processing unit 1220, and a policy change processing unit 1230. The API transmission/reception unit 1210, the clone processing unit 1220, and the policy change processing unit 1230 may be in a form of the same program as the API processing unit 1200, or alternatively, may be in a form in which at least a part thereof is combined and other parts thereof are separately independent. The API processing unit 1200 usually includes a processing unit for creating a virtual volume, and also includes other processing units such as a processing unit for setting a bind between the PE and the virtual volume.

The API transmission/reception unit 1210 transfers an instruction content transmitted from the host computer 200 to a program that executes processing for the instruction content, and transmits an execution result of the program that executes the processing for the instruction content to the host computer 200.

When a virtual volume clone instruction is transmitted from the host computer 200, the clone processing unit 1220 executes virtual copy clone creation processing for creating a clone volume by virtual copy. The clone processing unit 1220 is capable of executing the virtual copy clone creation processing, and determines whether a snapshot policy, which is an example of a policy, can be maintained due to an influence after the virtual copy clone creation processing is executed. In addition, examples of the policy include matters related to replication and quality of service (QoS).

The controller 111 has a policy related to creation of a clone volume, estimates, based on the policy, the number of clone volumes to be created, determines, based on the estimated number of clone volumes, the number of the existing clone volumes, and the upper limit of the number of clone volumes to be created by the virtual copy clone creation processing, which of the virtual copy clone creation processing and the physical copy clone creation processing is to be executed, and executes the processing. The clone volume is a snapshot. The policy related to the clone volume defines a creation cycle and a retention period of the snapshot. Hereinafter, the policy is also referred to as a “snapshot policy”. In the virtual copy clone creation processing, the clone processing unit 1220 creates a clone volume by the virtual copy when the snapshot policy is to be maintained, and creates a clone volume by the physical copy when the snapshot policy is not to be maintained.

The policy change processing unit 1230 executes policy change processing for changing the snapshot policy when a policy change instruction is transmitted from the host computer 200. The policy change processing unit 1230 is capable of executing the policy change processing, and dynamically changes a processing operation related to the virtual copy clone creation processing and the policy change processing according to whether the snapshot policy can be maintained due to the influence after the virtual copy clone creation processing is executed.

In the policy change processing, the policy change processing unit 1230 changes the snapshot policy as it is in a case in which the snapshot policy can be maintained, and in a case in which the snapshot policy cannot be maintained, the policy change processing unit 1230 executes the policy change processing after migrating, by volume migration, a policy change target volume, which is a target for changing the snapshot policy, or one or more volumes belonging to a snapshot/virtual clone tree as an example of a tree to which the policy change target volume belongs to a snapshot or after migrating a clone volume created by virtual copy to a clone volume created by physical copy. The tree is also referred to as Family, for example. In the present embodiment, the clone volume created by the virtual copy is also referred to as a “virtual clone”.

The policy change processing unit 1230 determines, regarding whether the snapshot policy is to be maintained, whether the upper limit of the snapshot/virtual clone tree is exceeded based on the assumed maximum number of snapshots calculated based on a snapshot cycle and a snapshot retention period that are included in the snapshot policy and the number of clone volumes created by the virtual copy. The clone volume includes a virtual clone volume and a snapshot volume. In the present embodiment, the virtual clone volume and the snapshot volume are managed with the same virtual clone tree ID as that of a volume serving as a basis of creation, and the upper limit is set for the number of volumes having the same virtual clone tree ID.

The controller 111 assigns another virtual clone tree ID to a part of the existing or to-be-created clone volumes having the same virtual clone tree ID, and manages the part separately when the number of clone volumes is estimated to exceed the upper limit. The controller 111 creates the clone volume by the virtual copy clone creation processing, and creates the clone volume by the physical copy clone creation processing when managing the clone volume separately by assigning the other virtual clone tree ID. The controller 111 creates the clone volume by the virtual copy clone creation processing, and creates the clone volume by the physical copy clone creation processing and manages the clone volume separately when managing the clone volume separately by assigning the other virtual clone tree ID.

The API management table 1400 is a table for managing information used by the API processing unit 1200. The API management table 1400 includes a virtual volume management table 1410 and a policy management table 1420.

The virtual volume management table 1410 is a table for managing the ID, type, and capacity of the virtual volume. The virtual volume management table 1410 is used by the clone processing unit 1220 and the policy change processing unit 1230.

The policy management table 1420 is a table for managing setting contents of the policy of each virtual volume. The policy management table 1420 is used by the clone processing unit 1220 and the policy change processing unit 1230.

The storage control unit 1300 includes a program for processing an IO request for a volume from the host computer 200, and a program for creating, deleting, and changing a logical resource of the storage node 100 according to instruction contents such as creation and deletion of a virtual volume, virtual copy clone creation processing, local copy clone creation processing, and snapshot processing received from the host computer 200 via the API processing unit 1200. Details of the virtual copy clone creation processing and the local copy clone creation processing will be described later. In the present embodiment, physical copying of data of an existing volume, that is, physically copying data of the existing volume, is also referred to as “local copy”.

In the present embodiment, a method for implementing a virtual volume by the storage control unit 1300 is to use a volume managed by the storage control unit 1300, for example. In the following description, an entity of the virtual volume managed by the API processing unit 1200 is, for example, the volume managed by the storage control unit 1300.

The storage control unit 1300 includes a snapshot/virtual clone processing unit 1310, a local copy processing unit 1320, and a volume migration processing unit 1330.

Although not illustrated, the storage control unit 1300 usually includes other processing units such as a processing unit for creating a volume for a virtual volume, a processing unit for creating a volume for the PE, and a processing unit for setting an IO path between the host computer 200 and the PE.

The snapshot/virtual clone processing unit 1310 executes processing when a snapshot/virtual clone instruction for a volume is transmitted from the API processing unit 1200. The snapshot and the virtual clone may be, for example, in a redirect-on-write (RoW) format that updates only metadata indicating a data storage position of a volume. The term “virtual clone” collectively refers to clone volumes created by virtual copy in the present embodiment.

Here, in the snapshot in the RoW format, data at the time of snapshot creation is shared by a snapshot creation source volume and the snapshot volume, and a data storage destination area is managed as meta information.

When data of the snapshot creation source volume or the snapshot volume is written by the I/O of the host, the snapshot/virtual clone processing unit 1310 does not overwrite the data before writing, stores the data to be written in a new data storage area of the volume, and rewrites the meta information so as to refer to the data stored in the new data storage area.

In the read by the I/O of the host, as described above, the data recorded in the meta information and stored in the data storage area is read. Therefore, for a data storage area in which data is not updated by the write of the I/O of the host after the snapshot is created, the data storage area shared by the snapshot creation source volume and the snapshot volume is referred to by the read.

The virtual clone is a volume clone method using the RoW format. The snapshot holds pair information of a snapshot source volume and a snapshot destination volume as storage management information. On the other hand, the virtual clone is a method of copying a volume in the RoW format without holding pair information.

The local copy processing unit 1320 executes local copy when a local copy instruction for a volume is transmitted from the API processing unit 1200. The local copy (physical copy) may be, for example, a format in which storage data in a copy source volume is physically copied to another volume having a different data storage position.

Unlike the snapshot, the local copy is a method of physically copying, without sharing data among a plurality of volumes, all data in a data storage area of a local copy creation source volume to a data storage area newly allocated for a local copy creation destination volume at the time of creating the local copy. Therefore, in an I/O of the host after the local copy is created, data is read from and written to different data storage areas in the local copy creation source volume and the local copy creation destination volume.

The volume migration processing unit 1330 executes volume migration when a migration instruction for a volume is transmitted from the API processing unit 1200. The volume migration may be in a format in which a migration source volume is deleted after storage data in the migration source volume is physically copied to another volume, or alternatively, may be in a format in which only metadata is changed without changing a data storage position. Migration of the snapshot or the virtual clone may be in a format in which storage data is physically copied to another volume and then metadata such as difference information for the snapshot or the virtual clone is deleted. In addition, the volume migration may be in a format in which not only storage data but also configuration management information such as a virtual volume ID and path information is migrated.

The storage management table 1500 is a table for managing information used by the storage control unit 1300. The storage management table 1500 includes a volume management table 1510, a snapshot/virtual clone management table 1520, a local copy management table 1530, and a volume migration management table 1540.

The volume management table 1510 is a table for managing a volume ID, association with a virtual volume, a capacity, and the like, and is used by the snapshot/virtual clone processing unit 1310, the local copy processing unit 1320, and the volume migration processing unit 1330.

The snapshot/virtual clone management table 1520 is a table for managing pair information, types, and states of a snapshot/virtual clone source volume serving as a primary volume (PVOL) and a snapshot/virtual clone destination volume serving as a secondary volume (SVOL). The snapshot/virtual clone management table 1520 is used by the snapshot/virtual clone processing unit 1310.

The local copy management table 1530 is a table for managing pair information and states of a local copy source volume serving as a primary volume (PVOL) and a local copy destination volume serving as a secondary volume (SVOL). The local copy management table 1530 is used by the local copy processing unit 1320.

The volume migration management table 1540 is a table for managing information and states of a migration source volume and a migration destination volume. The volume migration management table 1540 is used by the volume migration processing unit 1330.

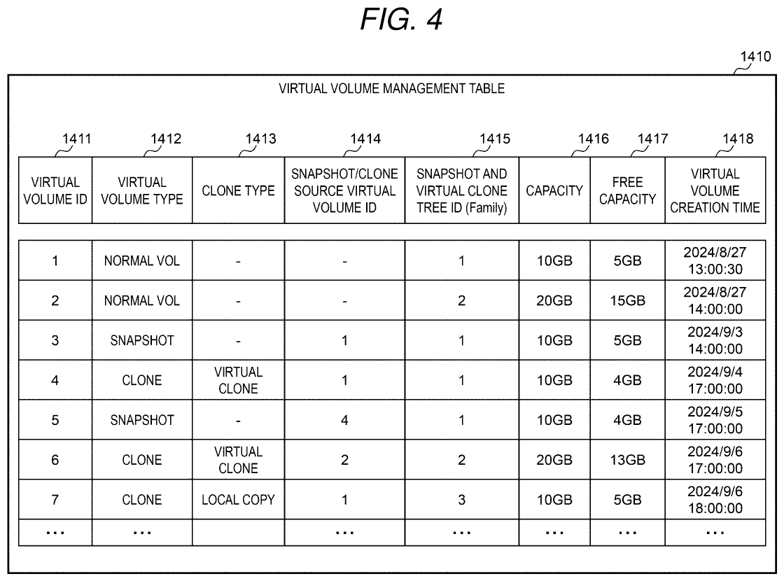

FIG. 4 is a configuration diagram of the virtual volume management table 1410 illustrated in FIG. 3. The virtual volume management table 1410 is a table for managing the ID, type, and capacity of the virtual volume. The virtual volume management table 1410 stores an entry for each virtual volume. The entry of the virtual volume management table 1410 includes fields of a virtual volume ID 1411, a virtual volume type 1412, a clone type 1413, a snapshot/clone source virtual volume ID 1414, a snapshot and virtual clone tree ID (Family) 1415, a capacity 1416, a free capacity 1417, and a virtual volume creation time 1418.

The virtual volume ID 1411 stores an identification number of the virtual volume corresponding to the entry. The virtual volume type 1412 stores a type of the virtual volume corresponding to the entry. As the type, for example, information that allows identification of “NORMAL VOL (normal volume)”, “SNAPSHOT”, “CLONE”, or the like may be stored.

The clone type 1413 stores a clone type of the virtual volume corresponding to the entry. As the clone type, when the virtual volume type 1412 is “CLONE”, information on what function is implemented by the clone volume may be stored. The clone type is set to, for example, “VIRTUAL CLONE” indicating a clone volume created by virtual copy or “LOCAL COPY” indicating a clone volume created by local copy (physical copy).

The snapshot/clone source virtual volume ID 1414 stores an ID of a snapshot/clone source virtual volume of the virtual volume corresponding to the entry. When the virtual volume type 1412 is “SNAPSHOT” or “CLONE”, the virtual volume ID 1411 of the virtual volume that is the source of the snapshot or clone of the virtual volume may be stored in the snapshot/clone source virtual volume ID 1414.

The snapshot and virtual clone tree ID (Family) 1415 stores an identification number of the snapshot and virtual clone tree to which the virtual volume corresponding to the entry belongs. Regarding the snapshot and virtual clone tree ID (Family) 1415, a virtual volume created by a snapshot or a virtual clone takes over the snapshot and virtual clone tree ID (Family) 1415 of a virtual volume serving as a snapshot and virtual clone source. For example, a certain virtual volume A and a virtual volume B created by a snapshot or a virtual clone for the virtual volume A have the same snapshot and virtual clone tree ID (Family) 1415. A virtual volume C created by a snapshot or a virtual clone for the virtual volume B has the same snapshot and virtual clone tree ID (Family) 1415 as the virtual volume A and the virtual volume B.

When a virtual volume is newly created as a normal VOL, the snapshot and virtual clone tree ID (Family) 1415 that does not overlap the snapshot and virtual clone tree ID (Family) 1415 of an existing entry is set.

On the other hand, when a virtual volume is newly created as a clone volume created by local copy, that is, as a virtual volume, the snapshot and virtual clone tree ID (Family) 1415 that does not overlap the snapshot and virtual clone tree ID (Family) 1415 of an existing entry is set.

The capacity 1416 stores a capacity of the virtual volume corresponding to the entry. The free capacity 1417 stores a free capacity of the virtual volume corresponding to the entry. The virtual volume creation time 1418 stores a time at which the virtual volume corresponding to the entry is created.

Next, an example of an image of a snapshot and virtual clone tree of a virtual volume will be described. The virtual clone tree is also referred to as, for example, “Family”.

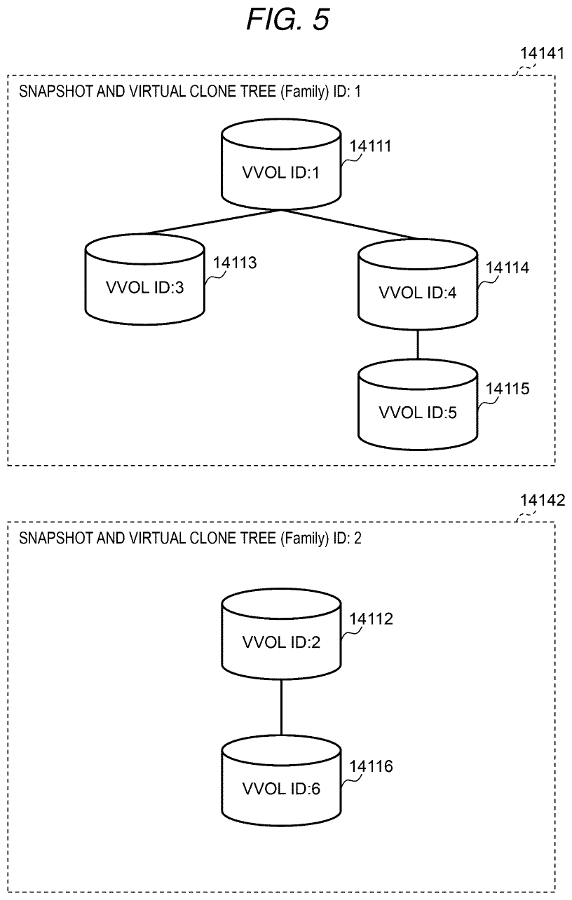

FIG. 5 illustrates image diagrams each illustrating a configuration example of the snapshot and virtual clone tree of a virtual volume according to the present embodiment. A snapshot and virtual clone tree 14141 illustrated in the drawing corresponds to the entry example of the virtual volume management table 1410 illustrated in FIG. 4. “VVOL” illustrated in the drawing indicates a virtual volume.

The snapshot and virtual clone tree 14141 with a snapshot and virtual clone tree ID of “1” includes a virtual volume 14111 with a virtual volume ID 1411 of “1” as a root of the tree. A virtual volume 14113 with a virtual volume ID of “3” that is created as a snapshot of the virtual volume 14111 belongs to the tree as a child of the virtual volume 14111. A virtual volume 14114 with a virtual volume ID of “4” that is created as a virtual clone of the virtual volume 14111 belongs to the tree as a child of the virtual volume 14111. A virtual volume 14115 with a virtual volume ID of “5” that is created as a snapshot of the virtual volume 14114 belongs to the tree as a child of the virtual volume 14114.

A virtual volume 14112 with a virtual volume ID of “2”, which is a normal VOL different from the virtual volume 14111, constitutes a tree with a snapshot and virtual clone tree ID of “2” that is different from that of the virtual volume 14111. A virtual volume 14116 with a virtual volume ID of “6” that is created as a virtual clone of the virtual volume 14112 belongs to the tree as a child of the virtual volume 14112.

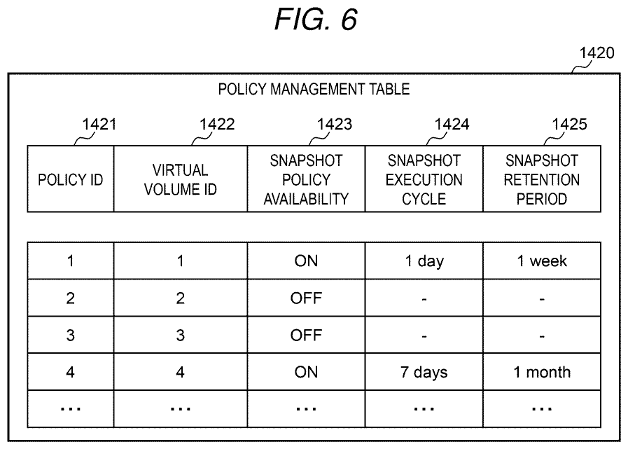

FIG. 6 is a diagram illustrating a configuration example of the policy management table 1420 illustrated in FIG. 3. The policy management table 1420 is a table for managing the setting contents of the policy of each virtual volume. The policy management table 1420 stores an entry for each policy.

The entry of the policy management table 1420 includes fields of a policy ID 1421, a virtual volume ID 1422, a snapshot policy availability 1423, a snapshot execution cycle 1424, and a snapshot retention period 1425.

The policy ID 1421 stores an identification number of a policy corresponding to the entry. The virtual volume ID 1422 stores an ID of the virtual volume corresponding to the entry. The virtual volume ID 1422 corresponds to the virtual volume ID 1411 in the virtual volume management table 1410.

The snapshot policy availability 1423 stores the snapshot related policy setting availability of the virtual volume corresponding to the entry. For example, the snapshot policy availability 1423 is set to “ON” when a snapshot policy is set, and is set to “OFF” when no snapshot policy is set.

The snapshot execution cycle 1424 stores a snapshot execution cycle of the virtual volume corresponding to the entry. The snapshot execution cycle 1424 is set to, for example, “1 day” or “1 hour” according to the end of a snapshot to be executed.

The snapshot retention period 1425 stores a snapshot retention period of the virtual volume corresponding to the entry. The snapshot retention period 1425 is set to, for example, “1 day” or “1 hour” according to a retention period of a snapshot to be executed.

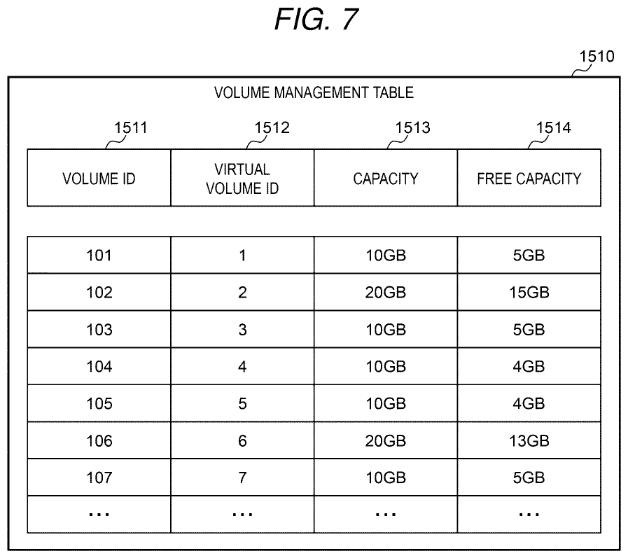

FIG. 7 is a configuration diagram of the volume management table 1510 illustrated in FIG. 3. The volume management table 1510 is a table for managing the virtual volume ID, the capacity, and the like of each volume. The volume management table 1510 stores an entry for each volume. The entry of the volume management table 1510 includes fields of a volume ID 1511, a virtual volume ID 1512, a capacity 1513, and a free capacity 1514.

The volume ID 1511 stores an identification number of the volume corresponding to the entry. The virtual volume ID 1512 stores an identification number of a virtual volume provided by the volume corresponding to the entry.

The capacity 1513 stores a capacity of the volume corresponding to the entry. The free capacity 1514 stores a free capacity of the volume corresponding to the entry.

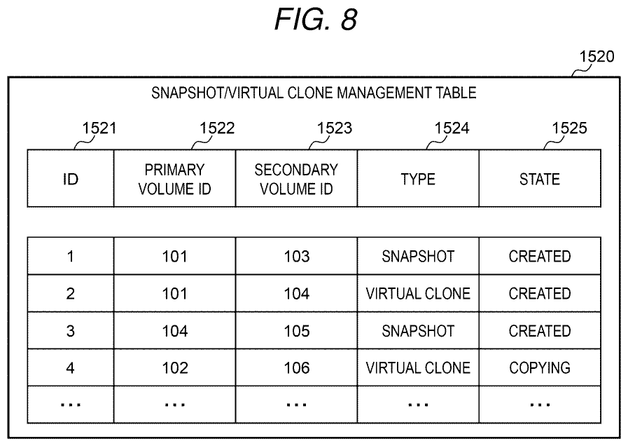

FIG. 8 is a diagram illustrating a configuration example of the snapshot/virtual clone management table 1520 illustrated in FIG. 3. The snapshot/virtual clone management table 1520 is a table for managing, for example, the pair information, the types, and the states of the snapshot/virtual clone source volume serving as a primary volume (PVOL) and the snapshot/virtual clone destination volume serving as a secondary volume (SVOL).

The snapshot/virtual clone management table 1520 stores an entry for each PVOL and SVOL pair. The entry of the snapshot/virtual clone management table 1520 includes fields of an ID 1521, a primary volume ID 1522, a secondary volume ID 1523, a type 1524, and a state 1525.

The ID 1521 stores an identification number of the pair corresponding to the entry. The primary volume ID 1522 stores an identification number of a PVOL of the pair corresponding to the entry. The primary volume ID 1522 corresponds to the volume ID 1511 in the volume management table 1510.

The secondary volume ID 1523 stores an identification number of an SVOL of the pair corresponding to the entry. The secondary volume ID 1523 corresponds to the volume ID 1511 in the volume management table 1510.

The type 1524 stores a type of the pair corresponding to the entry. The type 1524 is set to, for example, “SNAPSHOT” or “VIRTUAL CLONE”.

The state 1525 stores a state of the pair corresponding to the entry. The state 1525 is set to, for example, “CREATED” indicating that a pair has been created or “COPYING” indicating that a pair is being created.

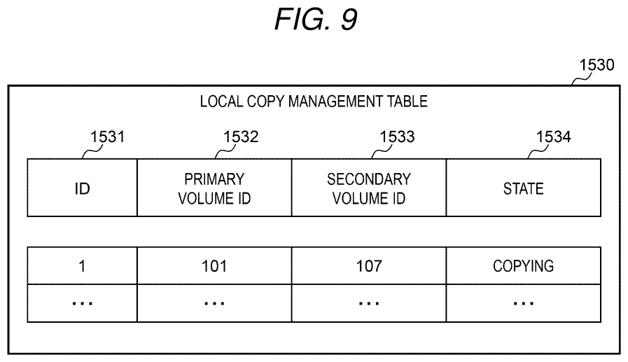

FIG. 9 is a diagram illustrating a configuration example of the local copy management table 1530 illustrated in FIG. 3. The local copy management table 1530 is a table for managing the pair information and the states of the local copy source volume serving as a primary volume (PVOL) and the local copy destination volume serving as a secondary volume (SVOL).

The local copy management table 1530 stores an entry for each PVOL and SVOL pair. The entry of the local copy management table 1530 includes fields of an ID 1531, a primary volume ID 1532, a secondary volume ID 1533, and a state 1534.

The ID 1531 stores an identification number of the pair corresponding to the entry. The primary volume ID 1532 stores an identification number of a PVOL of the pair corresponding to the entry. The primary volume ID 1532 corresponds to the volume ID 1511 in the volume management table 1510.

The secondary volume ID 1533 stores an identification number of an SVOL of the pair corresponding to the entry. The secondary volume ID 1533 corresponds to the volume ID 1511 in the volume management table 1510. The state 1534 stores a state of the pair corresponding to the entry. The state 1534 is set to, for example, “CREATED” or “COPYING”.

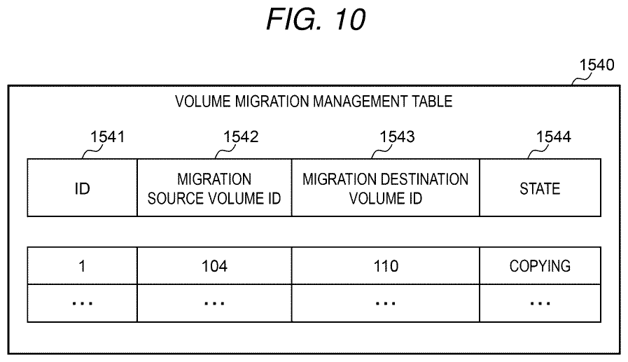

FIG. 10 is a diagram illustrating a configuration example of the volume migration management table 1540 illustrated in FIG. 3. The volume migration management table 1540 is a table for managing information and states of the migration source volume and the migration destination volume.

The volume migration management table 1540 stores an entry for each volume migration processing. The entry of the volume migration management table 1540 includes fields of an ID 1541, a migration source volume ID 1542, a migration destination volume ID 1543, and a state 1544.

The ID 1541 stores an identification number of the volume migration processing corresponding to the entry. The migration source volume ID 1542 stores an identification number of a migration source volume of the volume migration processing corresponding to the entry. The migration source volume ID 1542 corresponds to, for example, the volume ID 1511 in the volume management table 1510.

The migration destination volume ID 1543 stores an identification number of a migration destination volume of the volume migration processing corresponding to the entry. The migration destination volume ID 1543 corresponds to the volume ID 1511 in the volume management table 1510.

The state 1544 stores a state of the volume migration processing corresponding to the entry. The state 1544 is set to, for example, “COMPLETED” or “COPYING”.

The storage system 1000 according to the present embodiment has the configuration described above, and next, an overview of the overall flow of virtual volume clone processing and the policy change processing will be described.

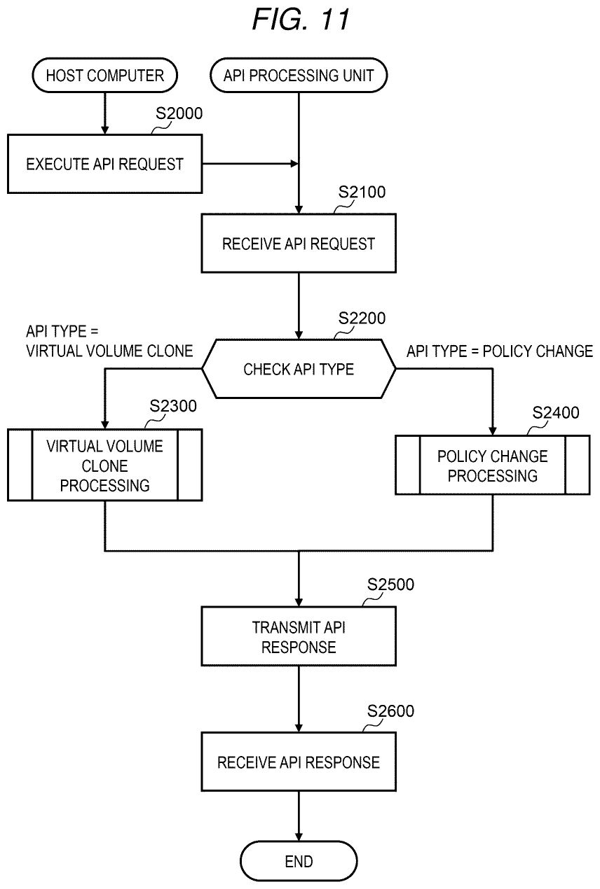

FIG. 11 is a flowchart illustrating an example of a storage management method including the virtual volume clone processing and the policy change processing according to the present embodiment.

First, the storage management method according to the present embodiment will be described. In the storage management method, the controller 111 is capable of executing the virtual copy clone creation processing of creating a clone volume by virtual copy sharing data with an existing volume and the physical copy clone creation processing of creating a clone volume by physically copying data from the existing volume, and determines, based on the number of existing and to-be-created clone volumes and an upper limit of the number of clone volumes to be created by the virtual copy clone creation processing, which of the virtual copy clone creation processing and the physical copy clone creation processing is to be executed, and executes the processing.

The host computer 200 transmits an API request to the API processing unit 1200 of the storage node 100 (step S2000). The API request is a request for operating management resources related to a virtual volume, such as “virtual volume creation”, “virtual volume deletion”, “virtual volume snapshot”, “virtual volume clone”, and “virtual volume policy change”.

The API transmission/reception unit 1210 of the API processing unit 1200 receives the API request (step S2100). The API transmission/reception unit 1210 of the API processing unit 1200 checks an API type (step S2200). The API type is, for example, information for determining what operation is to be executed by an API, such as “virtual volume creation”, “virtual volume deletion”, “virtual volume snapshot”, “virtual volume clone”, or “virtual volume policy change”.

When the API type is “virtual volume clone” indicating a clone volume created by virtual copy in step S2200, the clone processing unit 1220 executes the virtual volume clone processing (step S2300). Meanwhile, when the API type is “virtual volume policy change” in step S2200, the policy change processing unit 1230 executes the policy change processing (step S2400).

After step S2300 or step S2400 ends, the API transmission/reception unit 1210 transmits an API response to the host computer 200 (step S2500). The API response includes information such as a result of processing for the API request. Finally, the host computer 200 receives the API response from the API transmission/reception unit 1210 (step S2600).

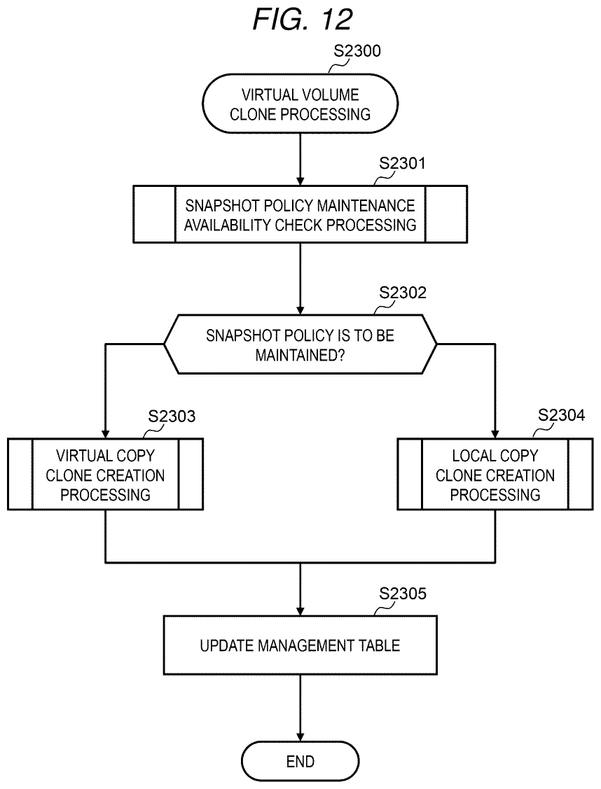

FIG. 12 is a flowchart illustrating an example of a procedure of the virtual volume clone processing (step S2300) illustrated in FIG. 11.

The clone processing unit 1220 executes snapshot policy maintenance availability check processing in the virtual volume clone processing (step S2301). The maintenance availability of the snapshot policy is information related to whether the snapshot can be created according to the snapshot cycle and the snapshot retention period set as the policy. For example, when the snapshot cycle and the snapshot retention period of any policy cannot be maintained due to the influence of the virtual volume clone processing, it is determined that the snapshot policy cannot be maintained.

The clone processing unit 1220 determines whether the snapshot policy can be maintained based on a check result in step S2301 (step S2302).

When the snapshot policy can be maintained in step S2302, the clone processing unit 1220 requests the snapshot/virtual clone processing unit 1310 of the storage control unit 1300 to execute virtual copy clone creation processing (step S2303).

Meanwhile, when the snapshot policy cannot be maintained in step S2302, the clone processing unit 1220 requests the local copy processing unit 1320 of the storage control unit 1300 to execute local copy clone creation processing (step S2304).

Finally, the clone processing unit 1220 updates the virtual volume management table 1410 based on results of steps S2303 and S2304 (step S2305). Specifically, for example, in S2303, when a virtual volume with a virtual volume ID of “10” is created in the virtual copy clone creation processing with a virtual volume with a virtual volume ID of “1” as a clone source, the clone processing unit 1220 newly creates an entry in which the virtual volume type 1412 is “CLONE”, the clone type 1413 is “VIRTUAL CLONE”, and the snapshot/clone source virtual volume ID 1414 is “1”.

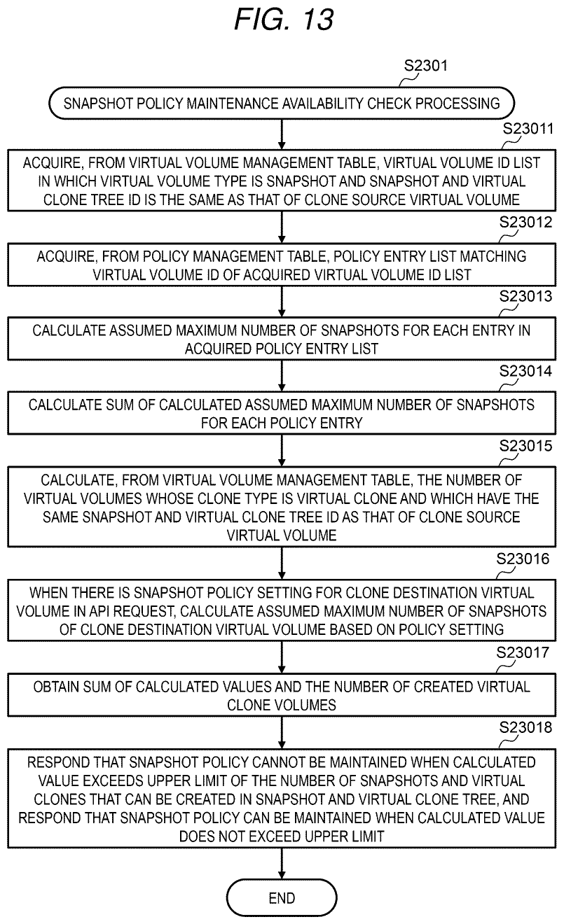

FIG. 13 is a flowchart illustrating an example of a procedure of the snapshot policy maintenance availability check processing illustrated in FIG. 12. The snapshot policy maintenance availability check processing is executed by the clone processing unit 1220.

The clone processing unit 1220 acquires, from the virtual volume management table 1410, a virtual volume ID list in which the virtual volume type is a snapshot and the snapshot and virtual clone tree ID is the same as the snapshot and virtual clone tree ID of a clone source virtual volume which is a clone target virtual volume (step S23011).

The clone processing unit 1220 acquires, from the policy management table 1420, a policy entry list matching the virtual volume ID of the virtual volume ID list acquired in step S23011 (step S23012).

The clone processing unit 1220 calculates the assumed maximum number of snapshots for each entry in the policy entry list acquired in step S23012 (step S23013). The assumed maximum number of snapshots refers to the number of snapshots required to implement the snapshot cycle and the snapshot retention period set as a policy. For example, the maximum number of snapshots that can be created by a virtual volume for which a policy is set in which the snapshot retention period is one week and the snapshot execution cycle is one day is, for example, 7 days/1 day=7.

The clone processing unit 1220 calculates the sum of the assumed maximum number of snapshots for each policy entry calculated in step S23013 (step S23014).

The clone processing unit 1220 calculates, from the virtual volume management table 1410, the number of virtual volumes whose clone type is a virtual clone and which have the same snapshot and virtual clone tree ID as the snapshot and virtual clone tree ID of the clone source virtual volume (step S23015).

When there is a snapshot policy setting for a clone destination virtual volume created by executing the virtual copy clone creation processing as the content of the API request, the clone processing unit 1220 calculates the assumed maximum number of snapshots of the clone destination virtual volume based on the policy setting (step S23016). The calculation method of the assumed maximum number of snapshots is the same as that in step S23013 described above. Meanwhile, when there is no snapshot policy setting, the clone processing unit 1220 sets the assumed maximum number of snapshots for the clone destination virtual volume to “0”.

The clone processing unit 1220 obtains the sum of the calculated values in steps S23014, S23015, and S23016 and the number of virtual clone volumes created in the virtual copy clone creation processing (step S23017).

Finally, the clone processing unit 1220 responds that the snapshot policy cannot be maintained when the calculated value in step S23017 exceeds an upper limit of the number of snapshots and virtual clones that can be created in the snapshot and virtual clone tree (hereinafter, also referred to as “storage system limit number”), and responds that the snapshot policy can be maintained when the calculated value does not exceed the upper limit. The upper limit of the number of snapshots and virtual clones that can be created (storage system limit number) may be set for each snapshot and virtual clone tree, or may be set for the entire storage system. In addition, the upper limit described above may be logically provided in advance as a specification of the storage control unit 1300 as an example of a storage control program, or may be determined from restrictions of physical resources such as a memory.

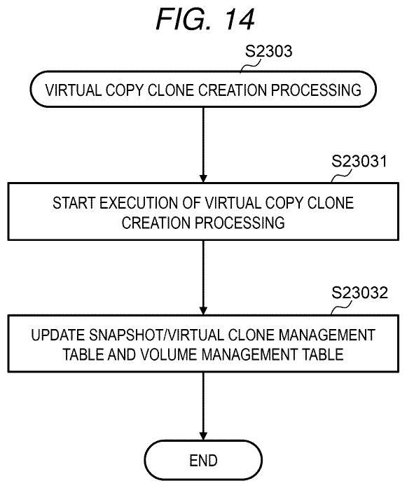

FIG. 14 is a flowchart illustrating an example of a procedure of the virtual copy clone creation processing (step S2303) illustrated in FIG. 12.

The snapshot/virtual clone processing unit 1310 of the storage control unit 1300 starts execution of the virtual copy clone creation processing (step S23031). The virtual clone may be, for example, in a redirect-on-write (RoW) format that updates only metadata indicating a data storage position of a volume.

The snapshot/virtual clone processing unit 1310 updates the snapshot/virtual clone management table 1520 and the volume management table 1510 based on a processing content of step S23031 and information of the volume created by the virtual clone (step S23032).

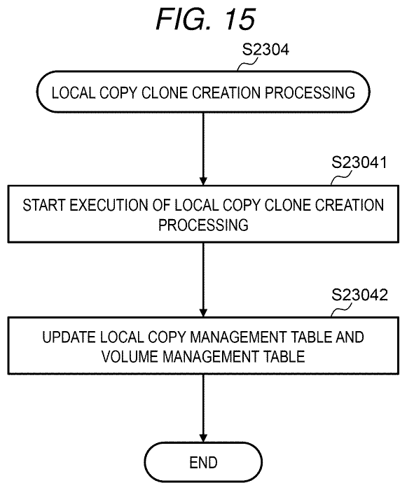

FIG. 15 is a flowchart illustrating an example of a procedure of the local copy clone creation processing (step S2304) illustrated in FIG. 12.

The local copy processing unit 1320 of the storage control unit 1300 starts execution of the local copy clone creation processing (step S23041). The local copy may be in a format in which storage data in a copy source volume is physically copied to another volume having a different data storage position.

The local copy processing unit 1320 updates the local copy management table 1530 and the volume management table 1510 based on a processing contents of step S23041 and information of the volume created by local copy (step S23042).

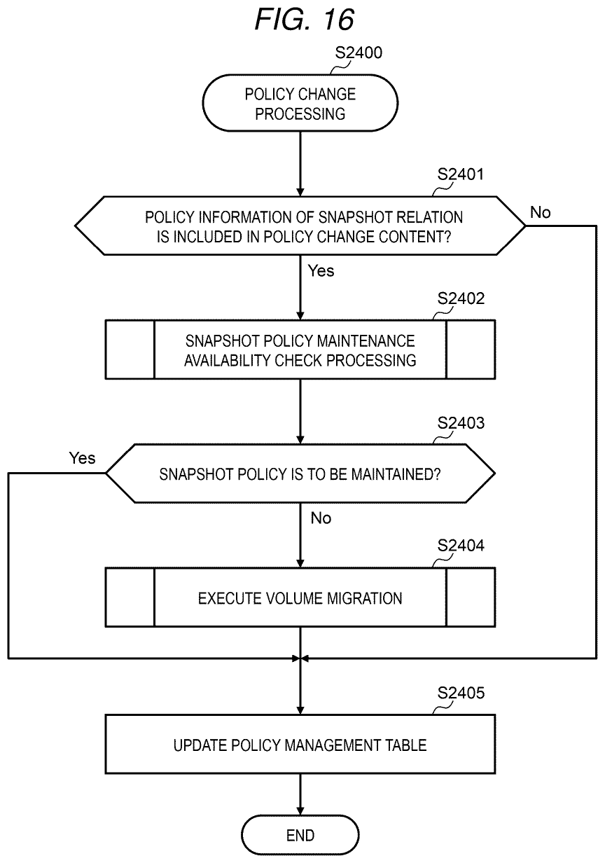

FIG. 16 is a flowchart illustrating an example of a procedure of the policy change processing (step S2400) illustrated in FIG. 11.

The policy change processing unit 1230 determines whether policy information of a snapshot relation is included as a policy change content (step S2401). The policy change processing unit 1230 executes step S2402 when the policy information of the snapshot relation is included, and executes step S2405 when the policy information of the snapshot relation is not included.

In step S2402, the policy change processing unit 1230 executes snapshot policy maintenance availability check processing in the policy change processing. The snapshot policy maintenance availability check processing is processing related to whether a snapshot can be created while maintaining the snapshot cycle and the snapshot retention period set as the policy. The policy change processing unit 1230 determines that the snapshot policy cannot be maintained, for example, when the snapshot cycle and the snapshot retention period, which are policies of any virtual volume, cannot be maintained due to the influence of the policy change processing.

The policy change processing unit 1230 determines whether the snapshot policy can be maintained based on a check result in step S2402 (step S2403). When determining in step S2303 that the snapshot policy can be maintained, the policy change processing unit 1230 executes step S2405. Meanwhile, when determining in step S2303 that the snapshot policy cannot be maintained, the policy change processing unit 1230 requests the volume migration processing unit 1330 to execute volume migration (step S2404). A virtual volume that is a volume migration target may be a virtual volume whose policy is to be changed, or may be one or more virtual volumes belonging to the same snapshot and virtual clone tree as the virtual volume whose policy is to be changed. However, when the one or more virtual volumes belonging to the same snapshot and virtual clone tree as the virtual volume whose policy is to be changed are migration targets, it is necessary to select a virtual volume to be migrated so that the assumed maximum number of snapshots does not exceed the upper limit so that the snapshot policy can be maintained.

Finally, the policy change processing unit 1230 updates the policy management table 1420 based on the policy change content described above (step S2405).

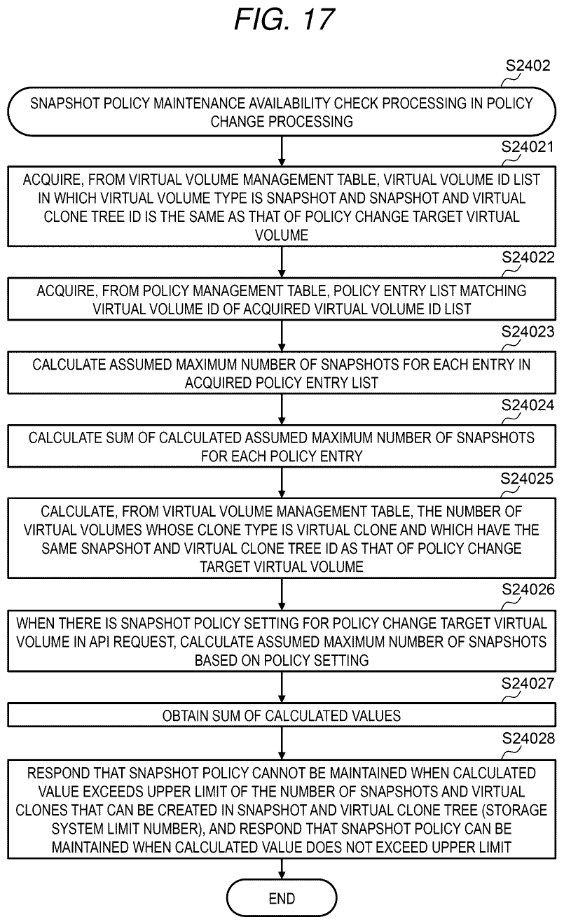

FIG. 17 is a flowchart illustrating an example of a procedure of the snapshot policy maintenance availability check processing (step S2402) in the policy change processing illustrated in FIG. 16. As described above, the clone volume includes the virtual clone volume and the snapshot volume. In the present embodiment, the virtual clone volume and the snapshot volume are managed with the same virtual clone tree ID as that of a volume serving as a basis of creation, and the upper limit is set for the number of volumes having the same virtual clone tree ID.

The policy change processing unit 1230 acquires, from the virtual volume management table 1410, a virtual volume ID list in which the virtual volume type is a snapshot and the snapshot and virtual clone tree ID is the same as the snapshot and virtual clone tree ID of a virtual volume whose policy is to be changed (step S24021).

The policy change processing unit 1230 acquires, from the policy management table 1420, a policy entry list matching the virtual volume ID of the virtual volume ID list acquired in step S24021 (step S24022).

The policy change processing unit 1230 calculates the assumed maximum number of snapshots for each entry of the policy list acquired in step S24022 (step S24023). The assumed maximum number of snapshots is the number of snapshots required to implement the snapshot cycle and the snapshot retention period set as a policy. For example, the maximum number of snapshots that can be created by a virtual volume for which a policy is set in which the snapshot retention period is one week and the snapshot execution cycle is one day is, for example, 7 days/1 day=7.

The policy change processing unit 1230 calculates the sum of the assumed maximum number of snapshots for each policy entry calculated in step S24023 (step S24024).

The policy change processing unit 1230 calculates, from the virtual volume management table 1410, the number of virtual volumes whose clone type is the virtual clone and having the same snapshot and virtual clone tree ID as the snapshot and virtual clone tree ID of a virtual volume whose policy is to be changed (step S24025).

When there is a snapshot policy setting for the virtual volume whose policy is to be changed as the content of the API request, the policy change processing unit 1230 calculates the assumed maximum number of snapshots based on the policy setting (step S24026). The calculation method of the assumed maximum number of snapshots is the same as that in step S24023 described above.

The policy change processing unit 1230 obtains the sum of the calculated values in steps S24024, S24025, and S24026 (step S24027).

Finally, the policy change processing unit 1230 responds that the snapshot policy cannot be maintained when the calculated value in step S24027 exceeds the upper limit of the number of snapshots and virtual clones that can be created in the snapshot and virtual clone tree (storage system limit number), and responds that the snapshot policy can be maintained when the calculated value does not exceed the upper limit.

Here, for the purposes of RoW format processing, the relation between the snapshot and the virtual clone and the creation source volume needs to be managed as a tree. When the snapshot and the virtual clone have the same creation source volume, the snapshot and the virtual clone are collectively managed in the same RoW management tree. The number of managed volumes (the creation source volume of the snapshot or the virtual clone, the snapshot volume, and the virtual clone volume) in the tree is limited due to restrictions such as the upper limit of physical resources (memories). Therefore, the upper limit of the tree management causes an upper limit to the number of snapshots and virtual clones that can be created for the same creation source volume.

The upper limit of the number of snapshots and virtual clones that can be created (storage system limit number) is set for each snapshot and virtual clone tree. Alternatively, the upper limit may be set for the entire storage system. The upper limit may be an upper limit logically provided in advance as a specification of the storage control unit 1300 as an example of the storage control program, or may be an upper limit determined from restrictions of the physical resources such as a memory.

In contrast, a clone volume created by physical copy does not need to maintain a relation with the source volume, and thus is not managed by the snapshot and virtual clone tree. Therefore, with respect to the clone volume created by physical copy, an upper limit does not occur in the number of clone volumes that can be created by physical copy for the creation source volume due to the upper limit managed by the snapshot and virtual clone tree of the snapshot and the virtual clone.

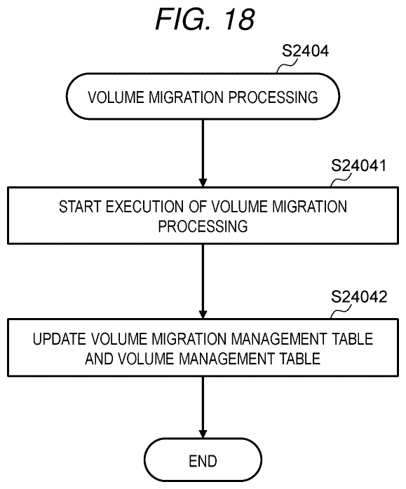

FIG. 18 is a flowchart illustrating an example of a procedure of the volume migration processing (step S2404) illustrated in FIG. 16.

The volume migration processing unit 1330 of the storage control unit 1300 starts execution of the volume migration processing (step S24041). The volume migration processing may be in a format in which a migration source volume is deleted after storage data in the migration source volume is physically copied to another volume, or alternatively, may be in a format in which only metadata is changed without changing a data storage position.

The volume migration processing unit 1330 updates the volume migration management table 1540 and the volume management table 1510 based on a processing content of step S24041 and information of the volume created by the volume migration (step S24042).

As described above, the storage system 1000 according to the present embodiment is a storage system including the storage device 130 as an example of a drive in which a volume for executing data input/output processing with the host computer 200 is created, and at least one controller 111 that controls the input/output processing. The controller 111 can execute the virtual copy clone creation processing of creating a clone volume by virtual copy sharing data with an existing volume and the physical copy clone creation processing of creating a clone volume by physically copying data from the existing volume. The controller 111 determines, based on the number of existing and to-be-created clone volumes and an upper limit of the number of clone volumes to be created by the virtual copy clone creation processing, which of the virtual copy clone creation processing and the physical copy clone creation processing is to be executed, and executes the processing.

In this way, since the processing operation related to the virtual copy clone creation processing and the policy change processing is dynamically changed according to whether the policy can be maintained due to the influence after the virtual copy clone creation processing is executed, the policy can be always maintained even when the clone volume is created by virtual copy.

In the present embodiment, the controller 111 has a policy related to creation of the clone volume, estimates, based on the policy, the number of clone volumes to be created, determines, based on the estimated number of the clone volumes, the number of the existing clone volumes, and the upper limit of the number of clone volumes to be created by the virtual copy clone creation processing, which of the virtual copy clone creation processing and the physical copy clone creation processing is to be executed, and executes the processing.

In the present embodiment, the clone volume is a snapshot. The policy related to the clone volume defines a creation cycle and a retention period of the snapshot.

In the present embodiment, in the virtual copy clone creation processing, the controller 111 creates a clone volume by the virtual copy when maintenance is allowed within the upper limit, and creates a clone volume by the physical copy when maintenance is not allowed within the upper limit. In this way, even when the number of clone volumes created by the virtual copy is to be continuously increased, the snapshot policy designated by the VM administrator can be continuously maintained. In addition, even when a large number of clone volumes are created as in a case in which physical copy is performed from the beginning and a clone volume is created by virtual copy, the consumption of a storage capacity can be prevented from becoming too large.

In the present embodiment, the policy change processing unit 1230 determines, regarding whether the snapshot policy is to be maintained, whether the upper limit of the snapshot/virtual clone tree is exceeded based on the assumed maximum number of snapshots calculated based on a snapshot cycle and a snapshot retention period that are included in the snapshot policy and the number of clone volumes created by the virtual copy.

In the present embodiment, the clone volume includes a virtual clone volume and a snapshot volume. The virtual clone volume and the snapshot volume are managed with a virtual clone tree ID the same as that of a volume serving as a basis of creation, and the upper limit is set for the number of volumes having the same virtual clone tree ID.

In the present embodiment, the controller 111 assigns another virtual clone tree ID to a part of the existing or to-be-created clone volumes having the same virtual clone tree ID, and manages the part separately when the number of clone volumes is estimated to exceed the upper limit.

In the present embodiment, the controller 111 creates the clone volume by the virtual copy clone creation processing, and creates the clone volume by the physical copy clone creation processing when managing the clone volume separately by assigning the other virtual clone tree ID.

In the present embodiment, the controller 111 creates the clone volume by the virtual copy clone creation processing, and creates the clone volume by the physical copy clone creation processing and manages the clone volume separately when managing the clone volume separately by assigning the other virtual clone tree ID.

In the present embodiment, since the snapshots and virtual clones for a volume are managed in a single group called the snapshot/virtual clone tree, when the snapshots and virtual clones are implemented on the storage system 1000 that has upper limits on physical resources such as the memory 120 and the storage device 130, the number of executable snapshots can be prevented from decreasing in a snapshot/virtual clone tree as the number of virtual clones in that snapshot/virtual clone tree is increased. In this way, when implementing the virtual clone, even if the number of virtual clones is continuously increased, the number of executable snapshots in the snapshot/virtual clone tree to which the virtual clone belongs does not decrease, so that the snapshot policy designated by the VM administrator can be always maintained. In addition, when implementing the virtual clone, in a situation in which the number of clone volumes is large, the VM administrator can validate or change the snapshot policy to always maintain the snapshot policy of the virtual volume in the snapshot/virtual clone tree to which the virtual volume whose policy is to be changed belongs.

The invention is not limited to the embodiment described above, and includes various modifications and equivalent configurations within the scope of the appended claims. For example, the embodiment described above has been described in detail to facilitate understanding of the invention, and the invention is not limited to those including all the configurations described above. At least one of the elements described as being connected in parallel in the present embodiment may be connected in series to another element.

### INDUSTRIAL APPLICABILITY

The invention can be applied to a storage system related to a technique for creating a clone volume by virtual copy.

What is claimed is:

1. A storage system comprising:
a drive configured to physically store data; and
at least one controller configured to provide a volume to a host computer and control input/output processing of data via the volume, wherein
the controller is configured to
execute virtual copy clone creation processing of creating a clone volume by virtual copy sharing data with an existing volume and physical copy clone creation processing of creating a clone volume by physically copying data from the existing volume, and
determine, based on the number of existing and to-be-created clone volumes and an upper limit of the number of clone volumes to be created by the virtual copy clone creation processing, which of the virtual copy clone creation processing and the physical copy clone creation processing is to be executed, and execute the processing.

2. The storage system according to claim 1, wherein
the controller has a policy related to creation of the clone volume, and
the controller is configured to estimate, based on the policy, the number of clone volumes to be created, determine, based on the estimated number of the clone volumes, the number of the existing volumes, and the upper limit of the number of clone volumes to be created by the virtual copy clone creation processing, which of the virtual copy clone creation processing and the physical copy clone creation processing is to be executed, and execute the processing.

3. The storage system according to claim 2, wherein
the clone volume is a snapshot, and
the policy related to the clone volume is configured to define a creation cycle and a retention period of the snapshot.

4. The storage system according to claim 1, wherein
in the virtual copy clone creation processing, the controller is configured to create a clone volume by the virtual copy when maintenance is allowed within the upper limit, and create a clone volume by the physical copy when maintenance is not allowed within the upper limit.

5. The storage system according to claim 2, wherein
the controller is configured to determine, regarding whether the policy is to be maintained, whether the upper limit is exceeded based on the assumed maximum number of snapshots calculated based on a snapshot cycle and a snapshot retention period that are included in the policy and the number of clone volumes created by the virtual copy.

6. The storage system according to claim 1, wherein
the clone volume includes a virtual clone volume and a snapshot volume,
the virtual clone volume and the snapshot volume are managed with a virtual clone tree ID the same as that of a volume serving as a basis of creation, and
the upper limit is set for the number of volumes having the same virtual clone tree ID.

7. The storage system according to claim 1, wherein
the controller is configured to assign another virtual clone tree ID to a part of the existing or to-be-created clone volumes having the same virtual clone tree ID, and manage the part separately when the number of clone volumes is estimated to exceed the upper limit.

8. The storage system according to claim 1, wherein
the controller is configured to
create the clone volume by the virtual copy clone creation processing, and
create the clone volume by the physical copy clone creation processing when managing the clone volume separately by assigning the other virtual clone tree ID.

9. The storage system according to claim 1, wherein
the controller is configured to
create the clone volume by the virtual copy clone creation processing, and
create the clone volume by the physical copy and manage the clone volume separately when managing the clone volume separately by assigning the other virtual clone tree ID.

10. A storage management method for a storage system, the storage system including a drive configured to physically store data, and at least one controller configured to provide a volume to a host computer and control input/output processing of data via the volume, the method comprising:
executing, by the controller, virtual copy clone creation processing of creating a clone volume by virtual copy sharing data with an existing volume and physical copy clone creation processing of creating a clone volume by physically copying data from the existing volume; and
determining, by the controller, based on the number of existing and to-be-created clone volumes and an upper limit of the number of clone volumes to be created by the virtual copy clone creation processing, which of the virtual copy clone creation processing and the physical copy clone creation processing is to be executed, and executing the processing.
